(19) United States
(12) Patent Application Publication
(10) Pub. No.: US 2003/0115511 A1
(43) Pub. Date: Jun. 19, 2003

(54) Method, apparatus and program for diagnosing system risk

(75) Inventor: Kyoko Kubota, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/316,158

(22) Filed: Dec. 11, 2002

(30) Foreign Application Priority Data
Dec. 13, 2001 (JP) 2001-380115

(51) Int. Cl. H02H 3/05

(52) U.S. Cl. 714/47

(57) ABSTRACT

A method and apparatus for diagnosing system risk are disclosed. A risk diagnosing server extracts from a risk information data base software risk information with which is associated for every item of software, risk level information obtained by quantifying risk estimated from problems that have been verified and sends the software risk information to a client terminal. The client terminal acquires software specifying information that specifies software used on the side of the client terminal, extracts data, conforming to the software specifying information used by the client terminal, from the risk information to perform self-diagnosis, and sends the result of self-diagnosis back to the risk diagnosing server. The latter then outputs the result of this self-diagnosis.

### FIELD OF THE INVENTION

This invention relates to a method, computer program product and apparatus for diagnosing system risk. More particularly, the invention relates to a risk diagnosis method of diagnosing system risk by diagnosing risk to which a client terminal is exposed, to a computer program product used to implement this method, and to an apparatus for carrying out the method.

### BACKGROUND OF THE INVENTION

At a time when the importance of overall system software is increasing (in the present specification, the software includes procedures relating to computer operation and information used in processing, etc., in addition to programs relating to computer operation), techniques for preventing system trouble before it arises have become vital. For example, the occurrence of malfunction in system security, maintenance and availability can lead to loss due to shutdown of operations, missed business opportunities and loss of social credibility. Devastating loss can be the result. At the same time, software itself has become increasingly complicated owing to diversification of system requirements, and the cost and labor required maintaining and managing such software present a major burden.

In order to alleviate the burden imposed, the specification of Japanese Patent Kokai Publication JP-A-5-313881 discloses a software quality assessment apparatus and method for supplying software having a high degree of reliability. Nevertheless, owing to limitations imposed by shipping timing and cost, it is difficult to conduct a quality assessment test that is perfect, and manufacturers are compelled to ship their products at such time they are estimated to have a certain degree of reliability.

### SUMMARY OF THE DISCLOSURE

Accordingly, it is an object of the present invention to provide a method, computer program product and apparatus for diagnosing system risk by ascertaining latent problems (also referred to as “threat”) in system software after the software has been shipped, supplying a user with the necessary information and preventing troubles before they occur to keep any damage to a minimum.

In accordance with one aspect of the present invention, the foregoing object is attained by providing a method of diagnosing system risk in a system including a client terminal, a risk information database for storing risk information with which risk level information, which is obtained by quantifying risk estimated from verified problems, is associated for every item of software specifying information that specifies software, and a risk diagnosing server for diagnosing risk of the client terminal, the method comprising the steps of: the risk diagnosing server extracting the risk information from the risk information database and sending the risk information to the client terminal; the client terminal obtaining software specifying information that specifies software used on the side of the local apparatus; the client terminal performing self-diagnosis by extracting data, which conforms to the software specifying information used on the side of the local apparatus, from the risk information; the client terminal sending result of the self-diagnosis to the risk diagnosing server; and the risk diagnosing server outputting the result of self-diagnosis sent from the client terminal.

Preferably, the method further comprises steps of the risk diagnosing server executing overall diagnosis of the client terminal by computing risk level information, of every piece of software, that is included in the result of self-diagnosis sent from the client terminal; and the risk diagnosing server outputting result of the overall diagnosis.

More detailed result of diagnosis can be provided by further providing the above-described method comprising steps of: the risk diagnosing server extracting software specifying information and risk level information of software updateable on the side of the client terminal from the risk information database based upon software specifying information included in the result of self-diagnosis sent from the client terminal; the risk diagnosing server executing overall diagnosis of the client terminal by computing risk level information, of every piece of software, included in the result of self-diagnosis sent from the client terminal; and the risk diagnosing server outputting the software specifying information and risk level information together with the result of overall diagnosis.

Further, in a case where storage location information of each piece of software has been stored in the risk information database, the above-described method further comprises the steps of: the risk diagnosing server extracting software specifying information, risk level information and storage location information of software updateable on the side of the client terminal from the risk information database based upon software specifying information included in the result of self-diagnosis sent from the client terminal; the risk diagnosing server executing overall diagnosis of the client terminal by computing risk level information, of every piece of software, included in the result of self-diagnosis sent from the client terminal; the risk diagnosing server generating, by using a markup language, contents including the software specifying information, risk level information, storage location information and result of overall diagnosis; and the risk diagnosing server sending the contents to the client terminal, thereby presenting risk information to a user to induce the user to download software. This makes it possible to implement a method through which risk is reduced rapidly by the downloading of software based upon result of diagnosis.

Further, it is preferred that the above-described method further comprises steps of: the client terminal storing the result of self-diagnosis of the local apparatus in storage means; and the client terminal outputting the stored result of self-diagnosis and to supply it to the user. This makes it possible to provide the user of the client terminal with the result of diagnosis rapidly.

In accordance with another aspect of the present invention, the foregoing object is attained by providing a method of diagnosing system risk in a system including a client terminal, a risk information database for storing risk information with which risk level information, which is obtained by quantifying risk estimated from verified problems, is associated for every item of software specifying information that specifies software, and a risk diagnosing server for diagnosing risk of the client terminal, the method comprising the steps of: the risk diagnosing server accessing the client terminal and obtaining software specifying information of software installed on the side of the client terminal; the risk diagnosing server performing diagnosis of the client terminal by extracting data, which conforms to the software specifying information regarding the software that has been installed on the side of the client terminal, from the risk information database; and the risk diagnosing server outputting result of diagnosis of the client terminal.

Preferably, the method further comprises steps of: the risk diagnosing server executing overall diagnosis of the client terminal by computing risk level information, of every piece of software, included in the result of self-diagnosis sent from the client terminal; and the risk diagnosing server to output result of the overall diagnosis.

Similarly, more detailed information can be provided by further providing the above-described method comprising steps of: the risk diagnosing server extracting software specifying information and risk level information of software updateable on the side of the client terminal from the risk information database based upon software specifying information included in the result of diagnosis of the client terminal; the risk diagnosing server executing overall diagnosis of the client terminal by computing risk level information, of every piece of software, included in the result of diagnosis of the client terminal; and the risk diagnosing server outputting the software specifying information and risk level information together with the result of overall diagnosis.

Further, in a case where storage location information of each piece of software has been stored in the risk information database, the above-described method further comprises the steps of: the risk diagnosing server extracting software specifying information, risk level information and storage location information of software updateable on the side of the client terminal from the risk information database based upon software specifying information included in the result of diagnosis of the client terminal; the risk diagnosing server executing overall diagnosis of the client terminal by computing risk level information, of every piece of software, included in the result of diagnosis of the client terminal; the risk diagnosing server generating, by using a markup language, contents including the software specifying information, risk level information, storage location information and result of overall diagnosis; and the risk diagnosing server sending the contents to the client terminal, thereby presenting risk information to the user to induce the user to download software. This makes it possible to implement a method through which risk is reduced rapidly by the downloading of software based upon result of diagnosis.

In accordance with a further aspect of the present invention directed toward implementing of the above-described method by a computer composing a client terminal and a risk diagnosing server, the foregoing object is attained by providing a program in which the steps included in the method of the above-described method are described.

In accordance with a further aspect of the present invention, the foregoing object is attained by providing a client terminal for storing the above-mentioned program in executable fashion and the risk-diagnosing server performing risk diagnosis of the client terminal.

In accordance with a further aspect of the present invention, the foregoing object is attained by providing a risk-diagnosing server for storing the above-mentioned program in executable fashion and performing risk diagnosis of the client terminal.

Similarly, there is provided a risk diagnosing server apparatus having an interface for communication over a computer network with at least one client terminal for diagnosing risk of said client terminal, said risk diagnosing server apparatus accessible with a risk information database for storing risk information with which risk level information, which is obtained by quantifying risk estimated from verified problems, is associated for every item of software specifying information that specifies software, the risk diagnosing server comprising: means for extracting the risk information from the risk information database and sending the risk information to the client terminal; means for receiving, from the client terminal, result of self-diagnosis of the client terminal obtained as a result of extraction of data, which conforms to the software specifying information used on the side of the client terminal, from the risk information; and means for outputting the result of self-diagnosis of the client terminal.

Preferably, the risk diagnosing server further includes means for executing overall diagnosis of the client terminal by computing risk level information, of every piece of software, included in the result of self-diagnosis sent from the client terminal; and means for outputting result of the overall diagnosis.

More detailed information is provided by the user by further providing the risk diagnosing server with means for extracting software specifying information and risk level information of software updateable on the side of the client terminal from the risk information database based upon software specifying information included in the result of self-diagnosis sent from the client terminal; means for executing overall diagnosis of the client terminal by computing risk level information, of every piece of software, included in the result of self-diagnosis sent from the client terminal; and means for outputting the software specifying information and risk level information together with the result of overall diagnosis.

Further, in a case where storage location information of each piece of software has been stored in the risk information database, the above-described risk diagnosing server further comprises: means for extracting software specifying information, risk level information and storage location information of software updateable on the side of the client terminal from the risk information database based upon software specifying information included in the result of self-diagnosis sent from the client terminal; means for executing overall diagnosis of the client terminal by computing risk level information of every piece of software included in the result of self-diagnosis sent from the client terminal; means for creating, by using a markup language, contents including the software specifying information, risk level information, storage location information and result of overall diagnosis; and means for sending the contents to the client terminal, presenting risk information to the user and inducing the user to download software. This makes it possible to provide a risk-diagnosing server that reduces risk promptly by having the user download software based upon result of diagnosis.

According to a further aspect of the present invention directed toward another risk diagnosing server for implementing the method of the present invention, the foregoing object is attained by providing a risk diagnosing server in a system including a client terminal, a risk information database for storing risk information with which risk level information, which is obtained by quantifying risk estimated from verified problems, is associated for every item of software specifying information that specifies software, and a risk diagnosing server for diagnosing risk of the client terminal, the risk diagnosing server comprising: means for accessing the client terminal and acquiring software specifying information regarding the software that has been installed on the side of the client terminal; means for performing diagnosis of the client terminal upon extracting data, which conforms to the software specifying information regarding the software that has been installed in the client terminal, from the risk information database; and means for outputting result of diagnosis of the client terminal.

Preferably, the risk diagnosing server further includes means for executing overall diagnosis of the client terminal by computing risk level information of every piece of software included in the result of self-diagnosis sent from the client terminal; and means for outputting result of the overall diagnosis.

More detailed information can be provided by further providing the risk diagnosing server with means for extracting software specifying information, risk level information and storage location information of software updateable on the side of the client terminal from the risk information database based upon software specifying information included in the result of self-diagnosis sent of the client terminal; means for executing overall diagnosis of the client terminal by computing risk level information, of every piece of software, included in the result of self-diagnosis sent from the client terminal; and means for outputting the software specifying information and risk level information together with the result of overall diagnosis.

Further, in a case where storage location information of each piece of software has been stored in the risk information database, the above-described risk diagnosing server further comprises: means for extracting software specifying information, risk level information and storage location information of software updateable on the side of the client terminal from the risk information database based upon software specifying information included in the result of diagnosis of the client terminal; means for executing overall diagnosis of the client terminal by computing risk level information, of every piece of software, included in the result of diagnosis of the client terminal; means for creating, by using a markup language, contents including the software specifying information, risk level information, storage location information and result of overall diagnosis; and means for sending the contents to the client terminal, presenting risk information to the user and inducing the user to download software. This makes it possible to provide a risk-diagnosing server that reduces risk promptly by having the user download software based upon result of diagnosis.

The software specifying information in the present invention comprises at least type-number information and edition-number information, and the edition-number information is composed of version number and revision number. This facilitates management.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram illustrating an example of the configuration of a system according to a first embodiment of the present invention;

FIG. 2 is a flowchart useful in describing the operation of the first embodiment;

FIG. 3 is a diagram illustrate one example of some registered items of a risk information data according to the present invention;

FIG. 4 is a diagram useful in describing the structure of a risk level table in simple terms;

FIG. 5 is a flowchart illustrating in detail one example of processing for creating client diagnosis information;

FIG. 6 is a diagram for rendering a simple description of the structure of client diagnosis information sent from a client terminal to a risk-diagnosing server;

FIG. 7 is a diagram for rendering a simple description of content written in a diagnostic-result file;

FIG. 8 is a diagram for rendering a simple description of the structure of an assessment table used in assessing overall system risk level of a client terminal;

FIG. 9 is a block diagram illustrating an example of the configuration of a system according to a second embodiment of the present invention; and

FIG. 10 is a flowchart useful in describing the operation of the second embodiment.

### DESCRIPTION OF THE PREFERRED EMBODIMENTS

Preferred embodiments of the present invention will now be described.

Preferred embodiments of the present invention are classified broadly into (1) a mode in which a client terminal performs self-diagnosis based upon risk information supplied from a risk diagnosing server and the risk diagnosing server analyzes the result of self-diagnosis and furnishes the final diagnostic result, and (2) a mode in which the risk diagnosing server performs the diagnosis of the client terminal, analyzes the data obtained and furnishes the result of diagnosis.

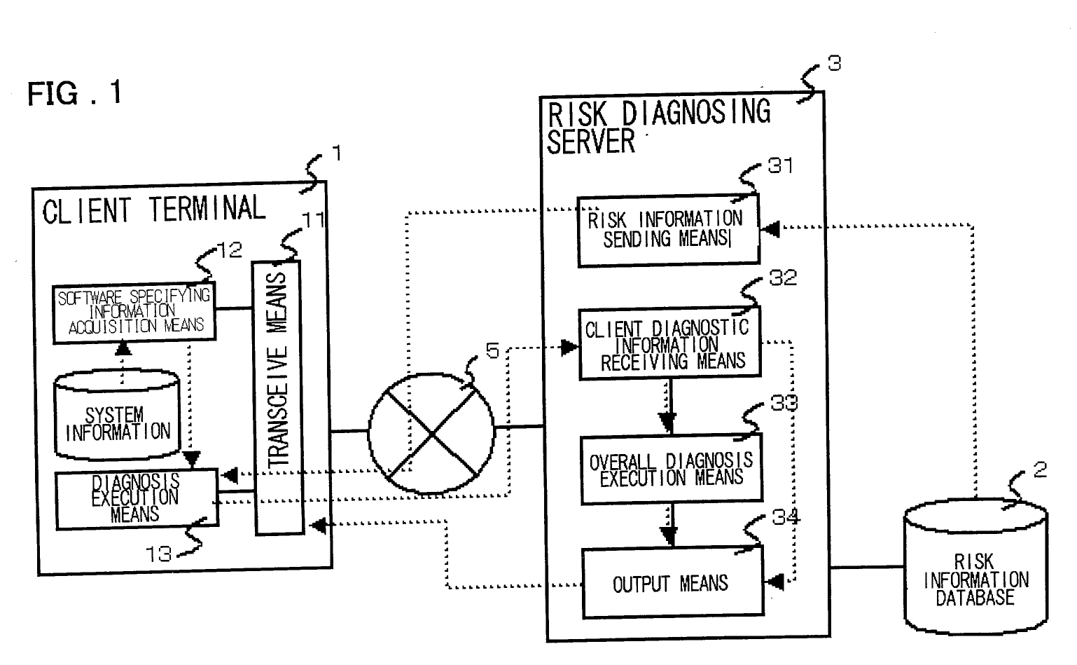

The former or first embodiment will be described first with reference to FIG. 1. In the first preferred embodiment of the present invention, a client terminal (1 in FIG. 1) receives risk information supplied by a risk-diagnosing server (3 in FIG. 1) and performs self-diagnosis locally. The client terminal includes send/receive means (11 in FIG. 1) for sending and receiving signals to and from the risk diagnosing server (3 in FIG. 1) via a network (5 in FIG. 1); software specifying information acquisition means (12 in FIG. 1) for acquiring software specifying information regarding the software that has been installed locally; and diagnosis execution means (13 in FIG. 1) for extracting data, which conforms to the software specifying information, based upon the risk information sent from the risk diagnosing server 3, and executing self-diagnosis.

Further, a risk information database (2 in FIG. 1) stores risk information with which risk level information, which is obtained by quantifying risk estimated from verified problems, is associated for every item of software specifying information that specifies software.

The risk diagnosing server (3 in FIG. 1) supplies risk information to the client terminal (1 in FIG. 1), receives the result of diagnosis and outputs the result. The risk diagnosing server has risk information sending means (31 in FIG. 1) for extracting the risk information from the risk information database (2 in FIG. 1) and sending the extracted information to the client terminal; client diagnostic information receiving means (32 in FIG. 1) for receiving result of self-diagnosis created on the side of the client terminal (1 in FIG. 1); and output means (34 in FIG. 1) for outputting the result of diagnosis.

In this embodiment of the present invention, the risk diagnosing server (3 in FIG. 1), which supplies the risk information to the client terminal (1 in FIG. 1), receives the result of diagnosis and outputs the result, further includes overall diagnosis execution means (33 in FIG. 1) for executing overall diagnosis by computing risk level information contained in the result of diagnosis.

Preferably, the risk diagnosing server (3 in FIG. 1) includes means for extracting, from the risk information database (2 in FIG. 1), software specifying information and risk level information of software updateable on the side of the client terminal (1 in FIG. 1).

Preferably, in a case where storage location information of each piece of software has been stored in the risk information database (2 in FIG. 1), the risk diagnosing server (3 in FIG. 1) further include means for extracting storage location information of software updateable on the side of the client terminal (1 in FIG. 1) from the risk information database (2 in FIG. 1) based upon software specifying information contained in the result of self-diagnosis of the client terminal (1 in FIG. 1); means for creating, by using a markup language, contents including the software specifying information, risk level information, storage location information and result of overall diagnosis; and means for sending the contents to the client terminal (1 in FIG. 1), presenting risk information to the user and inducing the user to download software.

By virtue of the above arrangement, the risk diagnosing server (3 in FIG. 1) sends risk information to the client terminal (1 in FIG. 1), whereupon the client terminal (1 in FIG. 1) performs self-diagnosis based upon the risk information and sends the result of diagnosis back to the risk diagnosing server (3 in FIG. 1). The risk diagnosing server (3 in FIG. 1) executes processing for outputting the result of self-diagnosis, the result of overall diagnosis obtained from the result of the self-diagnosis, or a proposal concerning measures (software that should be updated and the storage location of this software) that should be taken by the user of the client terminal (1 in FIG. 1).

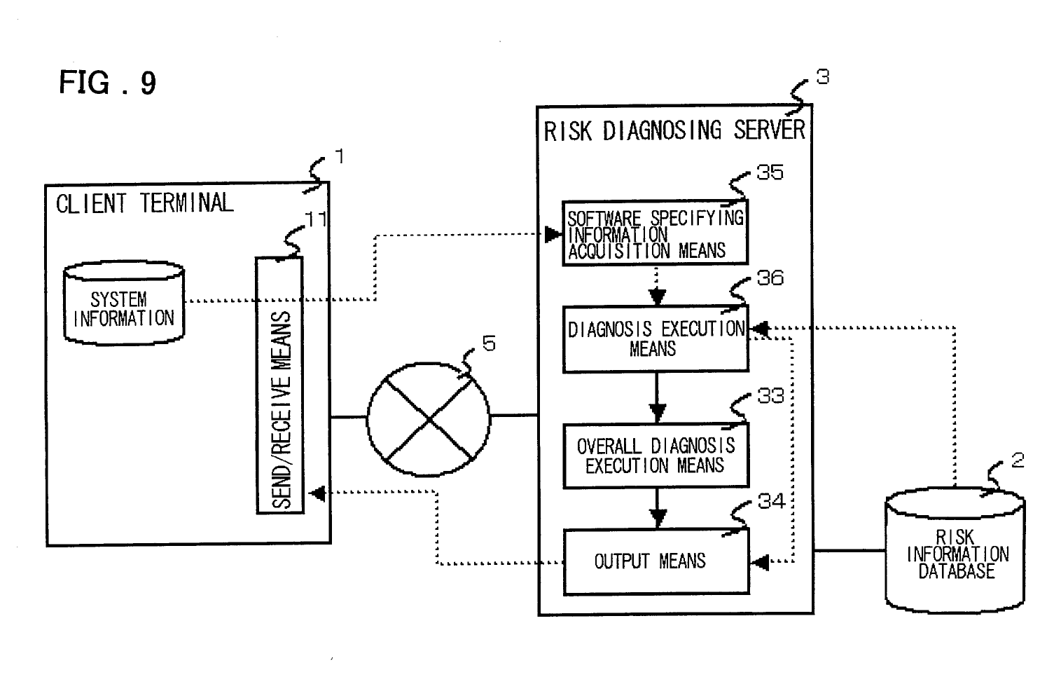

The second embodiment will be described with reference to FIG. 9.

In this embodiment of the present invention, the risk diagnosing server (3 in FIG. 9) acquires software specifying information used on the side of the client terminal (1 in FIG. 9), performs diagnosis and outputs the result. The risk diagnosing server includes software specifying information acquisition means (35 in FIG. 9) for acquiring software specifying information regarding the software which has been installed in the client terminal (1 in FIG. 9); diagnosis execution means (36 in FIG. 9) for extracting data, which conforms to the software specifying information, from the risk information database (2 in FIG. 9), and performing diagnosis; and output means (34 in FIG. 9) for outputting the result of the diagnosis.

Further, the risk information database (2 in FIG. 9) stores risk information with which risk level information, which is obtained by quantifying risk estimated from verified problems, is associated for every item of software specifying information that specifies software.

On the other hand, the client terminal (1 in FIG. 9), which supplies the risk diagnosing server (3 in FIG. 9) with software specifying information used locally and is to undergo diagnosis, includes sending/receiving means (11 in FIG. 9) for sending and receiving signals to and from the risk diagnosing server (3 in FIG. 9) via the network (5 in FIG. 9).

Preferably, the risk diagnosing server (3 in FIG. 9), which acquires software specifying information used on the side of the client terminal (1 in FIG. 9), performs diagnosis and outputs the result, includes overall diagnosis execution means (33 in FIG. 9) for executing overall diagnosis by computing risk level information contained in the result of diagnosis.

Preferably, the risk diagnosing server (3 in FIG. 9) includes means for extracting, from the risk information database (2 in FIG. 9), software specifying information and risk level information of software updateable on the side of the client terminal (1 in FIG. 9).

Preferably, in a case where storage location information of each piece of software has been stored in the risk information database (2 in FIG. 9), the risk diagnosing server (3 in FIG. 9) further include means for extracting storage location information of software updateable on the side of the client terminal 1 from the risk information database (2 in FIG. 9) based upon software specifying information contained in the result of self-diagnosis of the client terminal (1 in FIG. 9); means for creating, by using a markup language, contents including the software specifying information, risk level information, storage location information and result of overall diagnosis; and means for sending the contents to the client terminal (1 in FIG. 9), presenting risk information to the user and inducing the user to download software.

By virtue of the above arrangement, the risk diagnosing server (3 in FIG. 9) accesses the client terminal (1 in FIG. 9), acquires software specifying information used on the side of the client terminal (1 in FIG. 9) and diagnoses the client terminal (1 in FIG. 9) based upon the software specifying information. The risk diagnosing server (3 in FIG. 9) executes processing for outputting the result of the diagnosis, the result of overall diagnosis obtained from the result of the diagnosis, or a proposal concerning measures (software that should be updated and the storage location of this software) that should be taken by the user of the client terminal (1 in FIG. 9).

Embodiments of the present invention will now be described in detail.

A first embodiment of the present invention will be described in detail with reference to FIG. 1, which illustrates an example the configuration of a system according to the first embodiment.

As shown in FIG. 1, the system includes a client terminal 1 utilized on the customer side, a risk information database 2 and a risk diagnosing server 3 for diagnosing risk of the client terminal 1.

The client terminal 1, which is a customer information processing terminal connected to a network 5 such as an IP (Internet Protocol) network and installed in an office, home or public facility, includes sending/receiving means 11 such as a well-known browser for sending and receiving signals to and from the risk diagnosing server 3 via a the network 5; software specifying information acquisition means 12 for acquiring locally installed software specifying information from system information or the like; and diagnosis execution means 13 for extracting data, which conforms to the software specifying information, based upon risk information sent from the risk diagnosing server 3, and executing self-diagnosis.

The risk information database 2 is a database that stores risk level information, which is obtained by quantifying risk estimated from verified problems, as risk information for every item of software specifying information that specifies software through which the present system provides services.

The risk diagnosing server 3 is a server installed on the side of the software vendor and includes risk information sending means 31 for extracting the risk information from the risk information database 2 and sending the risk information to the client terminal 1; client diagnostic information receiving means 32 for receiving, from the client terminal 1, result of self-diagnosis of the client terminal 1 obtained by extracting data, which conforms to software specifying information used on the side of the client terminal 1, from the risk information; overall diagnosis execution means 33 for executing overall diagnosis by computing risk level information, for each piece of software, contained in the result of diagnosis of the client terminal 1; and output means 34 for outputting result of the overall diagnosis.

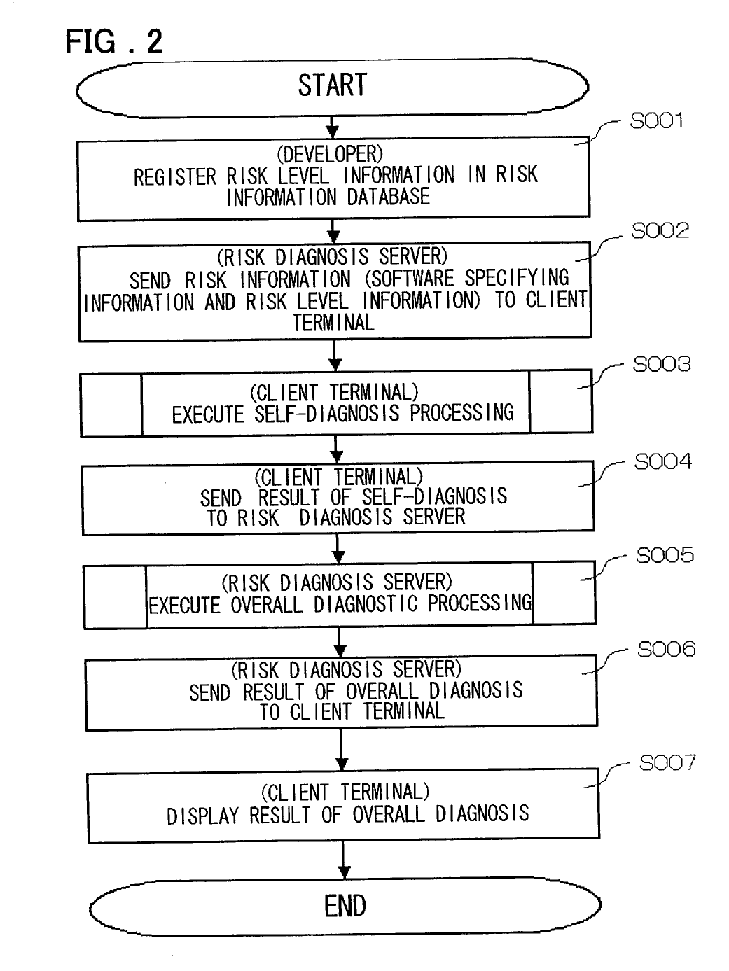

FIG. 2 is a flowchart useful in describing the operation of the first embodiment of the present invention. The overall operation of this embodiment will be described with reference to FIGS. 1 and 2.

When a problem or malfunction occurs in a program that has been shipped, the software developer that utilizes the present system uploads a modification program to a predetermined location and registers risk level information, which is obtained by quantifying risk estimated from the verified problem, in the risk information database 2 per item of software specifying information (type number, version/revision) of related software (step S001).

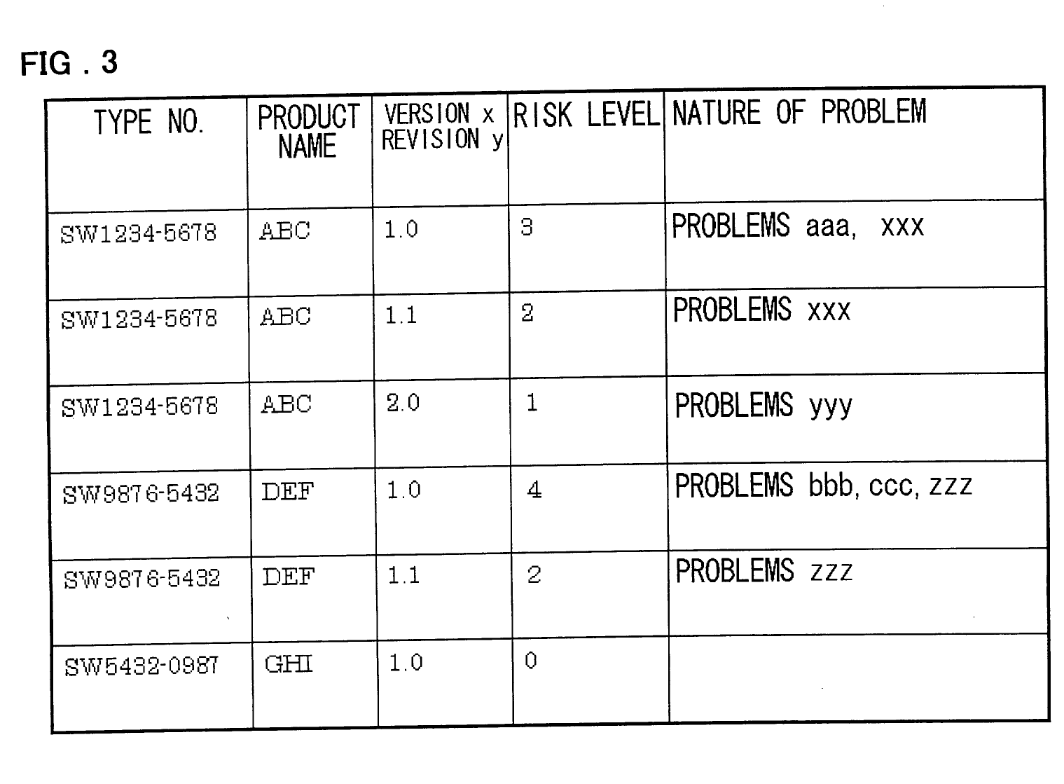

FIG. 3 illustrates an example of some of the registered items. The entered information includes software specifying information that includes the product type number, edition number (version and revisions), risk level information and contents of the problem. As shown in FIG. 3, “3” is the risk level of the client terminal 1 that uses Version 1.0 of product name “ABC”, by way of example. The reason for this risk level is that problem “aaa” and “xxx” have been verified. Similarly, “2” is the risk level of the client terminal 1 that uses Version 1.1 of product name “ABC”. The reason for this risk level is that problem “aaa” has been fixed(modification has been done) but not yet problem “xxx”. Furthermore, with regard to Version 2.0, the problems “aaa” and “xxx” have been fixed(modifications have been done) but a new problem “yyy” has been found. The risk level, therefore, is made “1” in this case.

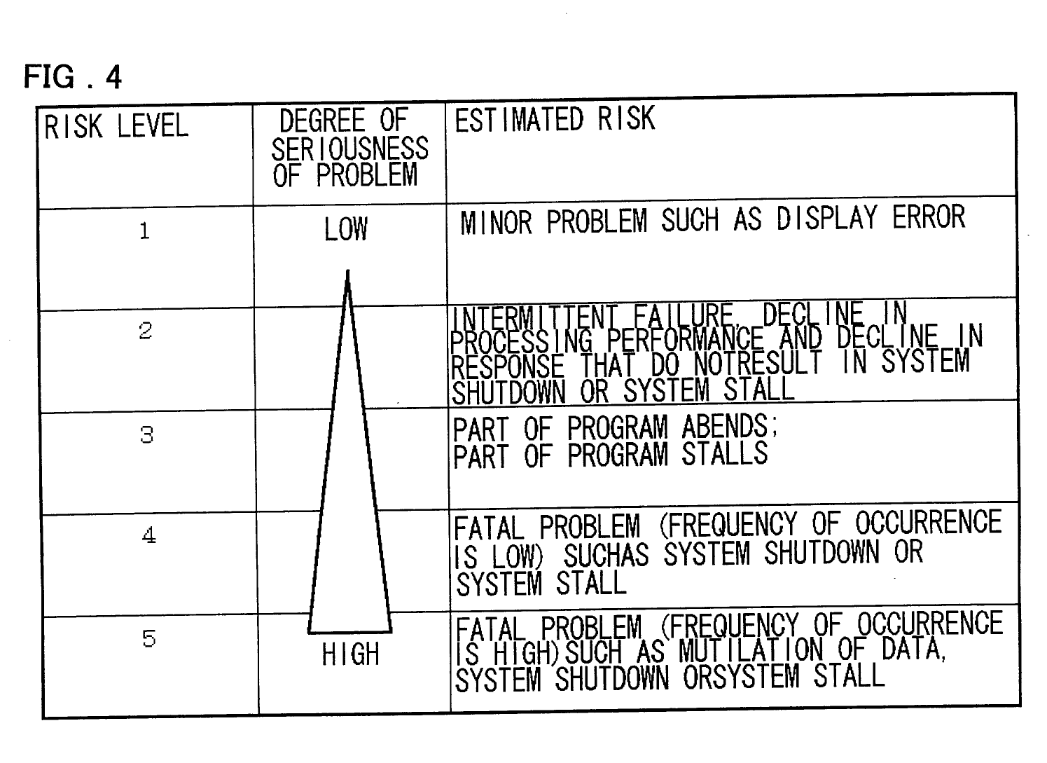

In the present invention, the method for quantifying the risk level is not particularly limited. By way of example, risk level is quantified in accordance with the degree of seriousness of the trouble which arose in the software, namely the magnitude of the risk estimated, using the risk level table of FIG. 4 as a reference. Since the software product of a version that has just been newly released will have no verified problems, naturally the risk level will be “0”. In an instance where a number of problems have been verified, a value that is the result of accumulating the risk levels of each of the problems is registered in the risk information database 2.

At predetermined intervals or in response to operation performed by the system administrator or the like, the risk information sending means 31 of the risk diagnosing server 3 sends the risk information, which has been stored in the risk information database 2, to the client terminal 1, which has been decided in advance as by agreement, via the network 5 (step S002).

The diagnosis execution means 13 of the client terminal 1 that has received the risk information via the sending/receiving means 11 starts self-diagnosis (step S003).

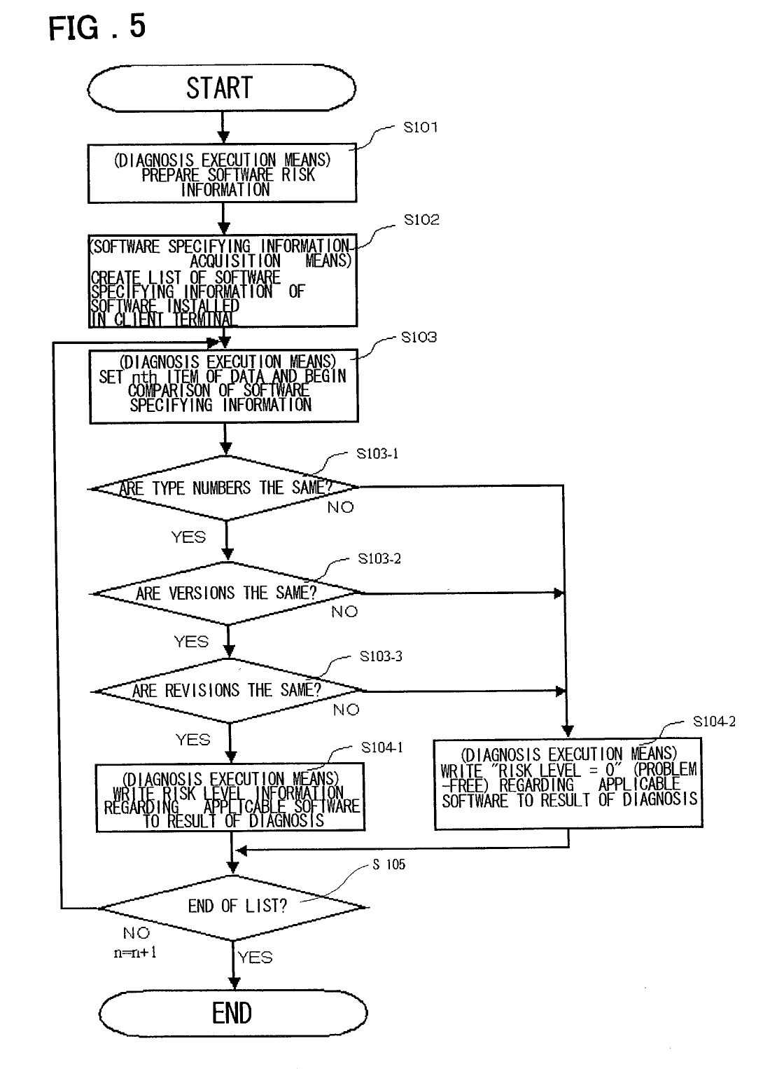

FIG. 5 is a flowchart illustrating, in greater detail, an example of risk diagnosis processing executed by the client terminal 1 at step S003 in FIG. 2. First, the diagnosis execution means 13 of the client terminal 1 prepares risk information (step S101). Upon receipt of the risk information, the software specifying information acquisition means 12 acquires system information, extracts the software locally installed in the own terminal and creates a list (step S102). Next, the diagnosis execution means 13 of the client terminal 1 starts matching process based upon the list created (step S103). First, the diagnosis execution means 13 compares the software type number with a type number of software included in the risk information (step S103-1). In a case where both type numbers are identical, the diagnosis execution means 13 compares the versions of these two pieces of software (step S103-2). If the version information is the same, then the diagnosis execution means 13 compares the revisions of these two pieces of software (step S103-3). If the type numbers, versions and revisions match, the diagnosis execution means 13 extracts the risk level information of this software from the risk information and appends the information to the client diagnosis information (step S104-1). On the other hand, if the product number, version or revision fails to match, the diagnosis execution means 13 construes that no problem has been reported with regard to this software and appends a risk level of “0” (problem-free) (step S104-2). Each of the above processing steps is repeated until the list of extracted software ends (“YES” at step S105). As a result, problems relating to the software that has been installed in the client terminal 1 are screened out.

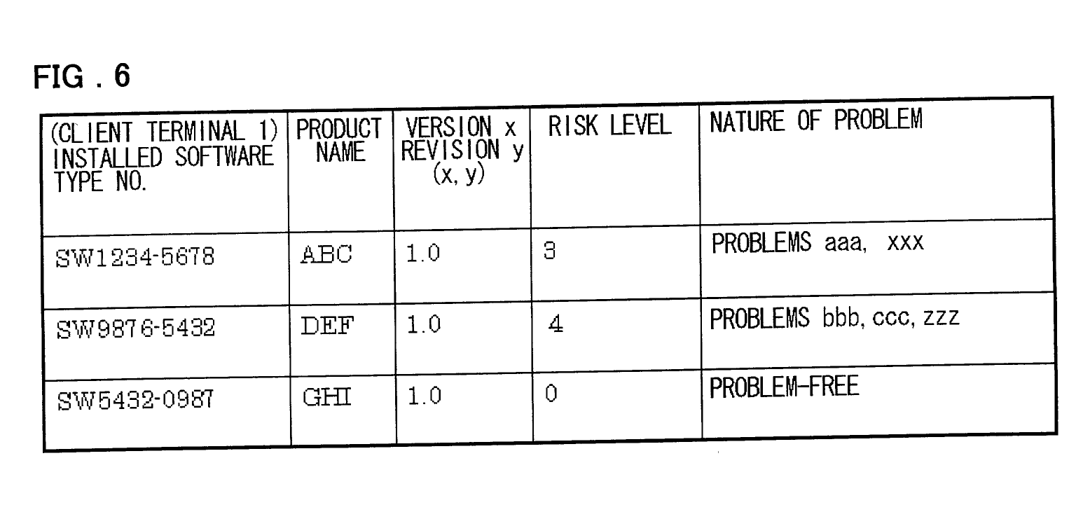

FIG. 6 shows an example of self-diagnosis information. This illustrates the result of self-diagnosis performed based upon the risk information of FIG. 3 in a case where Version 1.0 of software of each of the product names “ABC”, “DEF” and “GHI” has been installed in the client terminal.

When the above-described self-diagnosis is completed, the client terminal 1 sends the above-mentioned self-diagnosis information to the risk-diagnosing server 3 via the sending/receiving means 11 (step S004). The overall diagnosis execution means 33 of the risk diagnosing server 3 that has received the self-diagnosis information of the client terminal 1 performs overall diagnosis of the client terminal 1 by totalizing (calculating a cumulative sum of) the risk level information contained in the self-diagnosis information (step S005). Next, the output means 34 of the risk-diagnosing server 3 sends the result of overall diagnosis to the client terminal 1 (step S006). On receipt of the file containing the result of diagnosis, the client terminal 1 displays or prints out the result to supply it to the user (step S007).

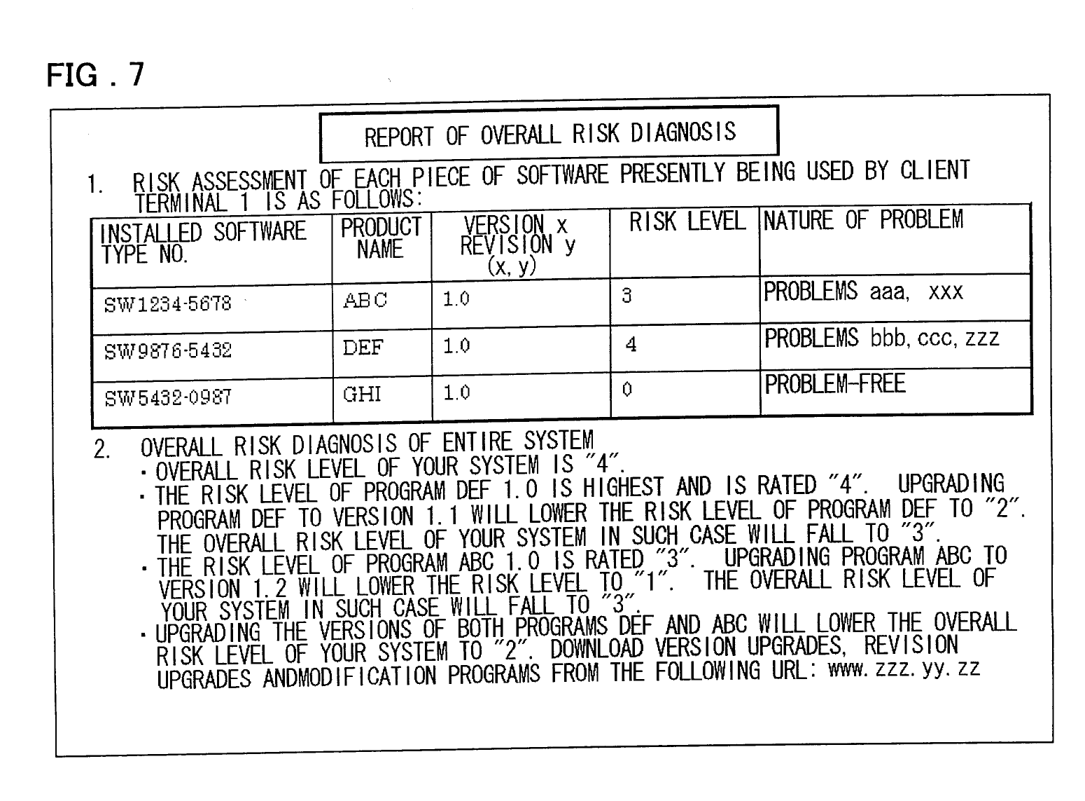

FIG. 7 illustrates an example of the contents send as the result of overall diagnosis. As shown in FIG. 7, the contents include the type numbers and edition numbers (versions and revisions) of the pieces of software that have been installed in the client terminal 1, risk level information of each piece of software, the overall risk level of the system calculated from the risk level information, a description relating to software that should be updated, the effects that will be obtained by such updating, and an URL (Uniform Resource Locator) for performing the download of a version up/revision up/modification program.

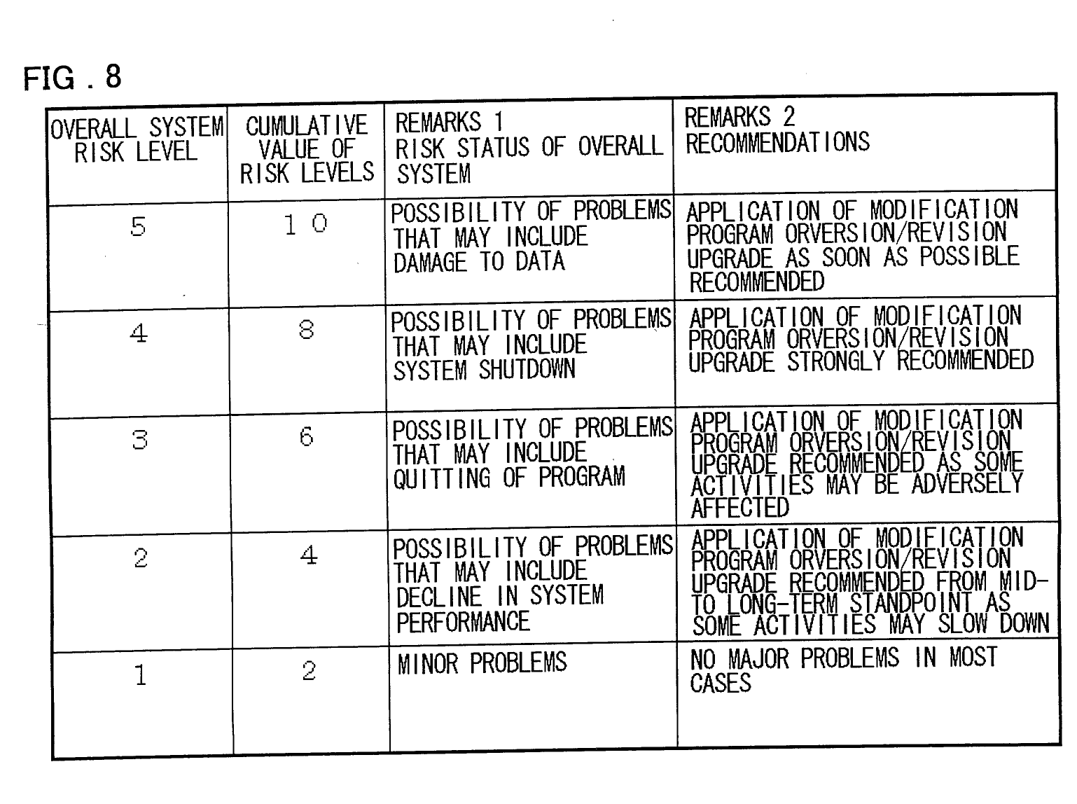

FIG. 8 shows an example of an assessment table used in assessing the overall risk level of the system. As shown in FIG. 8, the arrangement is such that the overall risk of the system rises when the cumulative sum of the risk levels of the pieces of software increases. For example, even if an individual piece of software has no major problem, an evaluation to the effect that the overall risk level of the system is high (i.e., that improvement is necessary) is rendered in a case where a number of minor problems are discovered.

The user of the client terminal 1 refers to the result of diagnosis provided thus far and decides to upgrade to a higher version or revision, to modify the applications used or to continue using the system as is.

In a case where a measure such as downloading of a modification program, upgrading to a higher version or revision or un-installation of software having a trouble is taken at the client terminal 1, the software specifying information is altered. When risk diagnosis is performed the next time, therefore, risk-level extraction based upon the new software specifying information is performed at the above mentioned step S003 without extracting the risk level relating to the software having the trouble. As a result, the overall risk level of the system diagnosed at the above mentioned step S005 is lowered.

Accordingly, by periodically taking suitable measures such as downloading of a modification program, upgrading to a higher version or revision or un-installation of the software with a trouble, the user of the client terminal 1 can maintain a low risk level. This makes it possible to suppress the occurrence of a serious situation such as damage to data or system shutdown.

Of course, the above-described overall evaluation method using the aforesaid calculations and assessment table is one example and does not impose a limitation upon the present invention. For example, the relationship between each item of risk level information and system status of an actual system may be approximated as by a polynomial in which the value of each item of risk level information is adopted as a variable, and the result of this calculation may be adopted as the overall risk level of the system.

Naturally, in the calculation of the overall risk level information of the system, it is preferred that weighting (coefficients) be applied in accordance with the type of software, e.g., operating system, middleware, driver, application, data file or component, etc.

The output destination and output medium of the output means 34 may involve output of data to the client terminal 1, as described above. However, this does not impose a limitation upon the invention. Information useful in managing individual client terminals and in providing support is supplied also by outputting data to a display unit or printer, etc., on the side of the risk diagnosing server.

It should be noted that the processing steps executed by the client terminal 1 preferably are implemented by installing an execution program, which executes the processing steps in a combined manner, in the client terminal 1. For example, it is recommended that an arrangement be adopted in which the risk-diagnosing server 3 is equipped with a file for installing the above-mentioned program so that the program can be downloaded from the risk-diagnosing server 3 to the client terminal 1.

As indicated at the bottom of FIG. 7, if the risk diagnosing server 3 is equipped with means (not shown) for extracting, from the risk information database 2, software specifying information and risk level information of software updateable at the client terminal 1, and this software specifying information and risk level information also is output as the result of overall diagnosis, then it becomes possible to implement a modification in which software updateable at the client terminal 1 by the user is proposed and the effects thereof described.

Furthermore, if storage location information concerning each piece of software is stored in the risk information database 2 and the risk diagnosing server 3 is equipped with means (not shown) for extracting the storage location information of software updateable on the side of the client terminal 1 from the risk information database 2 based upon software specifying information contained in the result of self-diagnosis of the client terminal 1, and means (not shown) for creating, by using a markup language such as HTML (HyperText Markup Language) or XML (eXtensible Markup Language), contents that include the software specifying information, risk level information, storage location information and result of overall diagnosis, then it becomes possible to implement a modification in which contents containing the URL of software to be acquired by the user is displayed on the client terminal 1 to induce the user to download modification software or the like.

Further, the risk diagnosing server 3 may be equipped with means for receiving risk level information, which is obtained by quantifying risk estimated from verified problems, for every item of software specifying information that specifies software, and registering the risk level information in the risk information database 2 as risk information, whereby processing for accepting risk information and registering it in the risk information database 2 may be executed.

A further preferred modification of the present embodiment is an arrangement in which when the client terminal 1 has received a user request to store self-diagnosis information for a predetermined period of time, the client terminal 1 displays this information for the user to see.

A second embodiment of the present invention will be described in detail with reference to FIG. 9, which illustrates an example the configuration of a system according to this embodiment.

As shown in FIG. 9, the system according to the second embodiment includes the client terminal 1 utilized on the customer side, the risk information database 2 and the risk diagnosing server 3 for diagnosing risk of the client terminal 1.

The client terminal 1, which is a customer information processing terminal connected to the network 5 such as an IP network and installed in an office, home or public facility, includes the sending/receiving means 11 such as a well-known browser for sending and receiving signals to and from the risk diagnosing server 3 via the network 5.

The risk information database 2 is a database that stores risk level information, which is obtained by quantifying risk estimated from verified problems, as risk information for every item of software specifying information that specifies software through which the present system provides services.

The risk diagnosing server 3 includes software specifying information acquisition means 35 for accessing the client terminal 1 at predetermined intervals and acquiring software specifying information on the software that has been installed in the client terminal 1; diagnosis execution means 36 for diagnosing the client terminal 1 upon extracting data, which conforms to the software specifying information on the software that has been installed in the client terminal 1, from the risk information database 2; the overall diagnosis execution means 33 for executing overall diagnosis of the client terminal 1 by computing risk level information, which is contained in the result of diagnosis of the client terminal 1, for every piece of software; and the output means 34 for outputting result of the overall diagnosis.

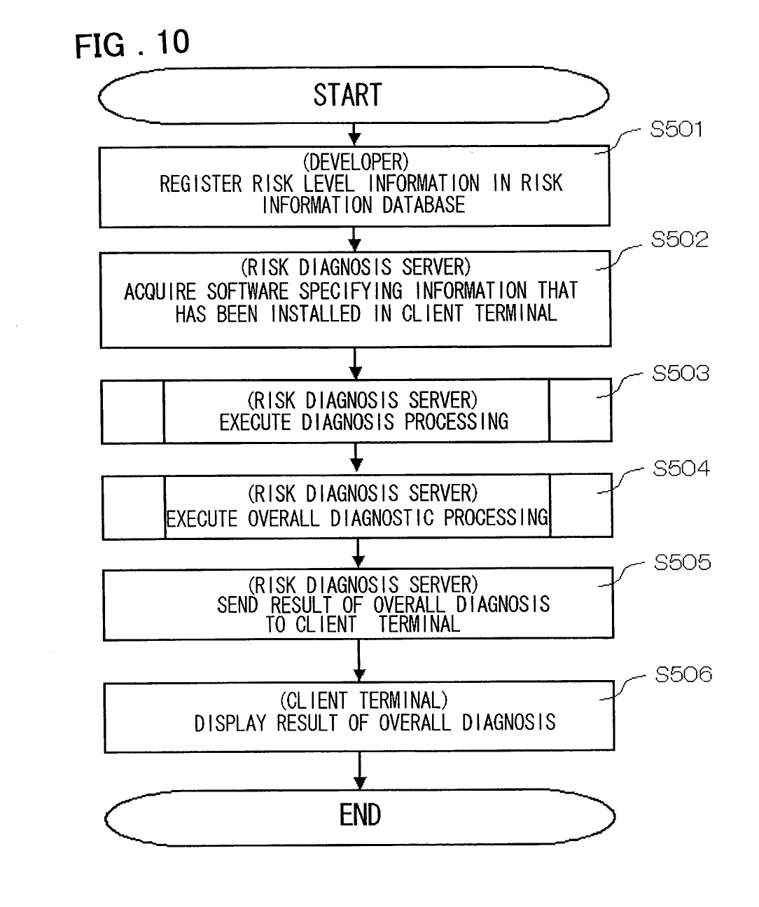

FIG. 10 is a flowchart useful in describing the operation of the second embodiment of the present invention. The overall operation of this embodiment will be described with reference to FIGS. 9 and 10.

When there is a problem in the program that has been shipped, the software developer that utilizes the present system uploads a modification program to the prescribed location and registers risk level information, which is obtained by quantifying risk estimated from the verified problem, in the risk information database 2 per item of software specifying information (type number, version/revision) of related software (step S501).

At fixed intervals or in response to operation performed by the system administrator or the like, the software specifying information acquisition means 35 of the risk diagnosing server 3 accesses the client terminal 1 and acquires software specifying information on the software, which has been installed in the client terminal 1, from the system information, etc. (step S502).

Next, the diagnosis execution means 36 of the risk diagnosing server 3 executes diagnosis of the client terminal 1 upon extracting data, which conforms to the software specifying information on the software that has been installed in the client terminal 1, from the risk information database 2 (step S503). The overall diagnosis execution means 33 of the risk diagnosing server 3 performs overall diagnosis of the client terminal 1 by totalizing the risk level information contained in the extracted data (step S504). Next, the output means 34 of the risk-diagnosing server 3 sends the result of overall diagnosis to the client terminal 1 (step S505). On receipt of the results of overall diagnosis via the sending/receiving means 11, the client terminal 1 provides the results to the user by displaying the results (step S506).

Thus, in this embodiment, the client terminal 1 merely supplies the risk diagnosing server 3 with software specifying information on the software that has been installed in the client terminal 1 locally, and the risk diagnosing server 3 then executes processing up to that for creating the diagnostic results. This makes it possible to simplify the structure of the client terminal 1.

The embodiments of the present invention are as described above but it goes without saying that the present invention is not limited to these embodiments. For example, the risk-diagnosing server 3 may be constituted by a group of two or more connected servers. Further, the network 5 may be a LAN (Local Area Network) or a WAN (Wide Area Network), and the client terminal 1 may be a single terminal constructing a LAN or WAN.

Further, in a case where the risk diagnosing server 3 is equipped with access means for accessing the risk information database that stores modification software and the client terminal is diagnosed periodically and software to be updated exists, or in a case where the risk level information exceeds a threshold value, it becomes possible to implement a modification in which this software is sent to the client terminal 1. In this case, the burden on the side of the user is greatly alleviated.

The meritorious effects of the present invention are summarized as follows.

Thus, in accordance with the present invention as described above, a system user is provided with necessary information, thereby making it possible to prevent trouble before it occurs and to minimize any damage caused by such trouble. The reason for this is that the present invention makes it easier to ascertain latent problems mainly ascribable to software and allows the user to take the proper action to deal with such problems.

Further, in accordance with the present invention, it is possible to reduce the cost and labor necessary to maintain and manage the system. The reason for this is that risk-related information is centralized, allowing knowledge to be shared, and that risk diagnosis can be performed in simple fashion even by the system user. An attendant advantage is that smooth system operation is achieved, as a result of which greater user satisfaction is obtained.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A method of diagnosing system risk in a system including at least one client terminal, a risk information database for storing risk information with which risk level information obtained by quantifying risk estimated from a verified problem, is associated for every item of software specifying information that specifies software, and a risk diagnosing server for diagnosing risk of the client terminal, the method comprising the steps of:
said risk diagnosing server extracting risk information from the risk information database to send the risk information to the client terminal;
said client terminal obtaining software specifying information that specifies software used on the side of said client terminal;
said client terminal extracting data conforming to the software specifying information for the software used on the side of said client terminal from the risk information to perform self-diagnosis;
said client terminal sending result of the self-diagnosis to said risk diagnosing server; and
said risk diagnosing server outputting the result of self-diagnosis sent from said client terminal.

2. The method according to claim 1, further comprising the steps of:
said risk diagnosing server executing overall diagnosis of said client terminal by computing risk level information, of every piece of software, included in the result of self-diagnosis sent from said client terminal; and
said risk diagnosing server outputting result of the overall diagnosis.

3. The method according to claim 1, further comprising the steps of:
said risk diagnosing server extracting software specifying information and risk level information of software updateable on the side of said client terminal from said risk information database based upon the software specifying information included in the result of self-diagnosis sent from said client terminal;
said risk diagnosing server executing overall diagnosis on the side of said client terminal by computing risk level information, of every piece of software, included in the result of self-diagnosis sent from said client terminal; and
said risk diagnosing server outputting the software specifying information and the risk level information together with the result of the overall diagnosis.

4. A method of diagnosing system risk in a system including at least one client terminal, a risk information database for storing, in associated form as risk information for every item of software specifying information that specifies software, risk level information obtained by quantifying risk estimated from verified problems, and software storage location information of said software, and a risk diagnosing server for diagnosing risk of said client terminal, the method-comprising the steps of:
said risk diagnosing server extracting the risk information from said risk information database to send the risk information to said client terminal;
said client terminal obtaining software specifying information of software used on the side of said client terminal;
said client terminal extracting data conforming to the software specifying information used on the side of said client terminal, from the risk information to perform self-diagnosis;
said client terminal sending result of the self-diagnosis to said risk diagnosing server;
said risk diagnosing server extracting software specifying information, risk level information and storage location information of software updateable on the side of said client terminal from said risk information database, based upon software specifying information included in the result of self-diagnosis sent from said client terminal;
said risk diagnosing server performing overall diagnosis of said client terminal by computing risk level information, of every piece of software, included in the result of self-diagnosis sent from said client terminal;
said risk diagnosing server generating, by using a markup language, contents including the software specifying information, the risk level information, the storage location information and the result of the overall diagnosis; and
said risk diagnosing server sending the contents to said client terminal, thereby presenting risk information to a user of said client terminal to induce the user to download software.

5. The method according to claim 1, further comprising the steps of:
said client terminal storing the result of the self-diagnosis on the side of the said client terminal in storage means; and
said client terminal outputting the stored result of the self-diagnosis and supplying the stored result of self-diagnosis to a user of said client terminal.

6. A method of diagnosing system risk in a system including at least one client terminal, a risk information database for storing risk information with which risk level information, obtained by quantifying risk estimated from verified problems, is associated for every item of software specifying information that specifies software, and a risk diagnosing server for diagnosing risk of the client terminal, the method comprising the steps of:
said risk diagnosing server making an access to said client terminal to obtain software specifying information of software installed on the side of said client terminal;
said risk diagnosing server extracting data conforming to the software specifying information of software installed on the side of said client terminal, from said risk information database to perform diagnosis of said client terminal; and
said risk diagnosing server outputting result of diagnosis of said client terminal.

7. The method according to claim 6, further comprising the steps of:
said risk diagnosing server performing overall diagnosis of said client terminal by computing risk level information, of every piece of software, included in the result of diagnosis of the client terminal, and said risk diagnosing server outputting result of the overall diagnosis.

8. The method according to claim 6, further comprising the steps of:
said risk diagnosing server extracting software specifying information and risk level information of software updateable on the side of said client terminal from said risk information database, based upon software specifying information included in the result of diagnosis of said client terminal;
said risk diagnosing server performing overall diagnosis of said client terminal by computing risk level information, of every piece of software, included in the result of diagnosis of said client terminal; and
said risk diagnosing server outputting the software specifying information and the risk level information together with the result of overall diagnosis.

9. A method of diagnosing system risk in a system including at least one client terminal, a risk information database for storing, in associated form as risk information for every item of software specifying information that specifies software, risk level information, obtained by quantifying risk estimated from verified problems, and storage location information of said software, and a risk diagnosing server for diagnosing risk of said client terminal, the method comprising the steps of:
said risk diagnosing server making an access to said client terminal to obtain software specifying information of software installed on the side of said client terminal;
said risk diagnosing server extracting data conforming to the software specifying information of software installed on the side of said client terminal, from said risk information database to perform diagnosis of said client terminal;
said risk diagnosing server extracting software specifying information, risk level information and storage location information of software updateable on the side of said client terminal from said risk information database based upon software specifying information included in the result of diagnosis of said client terminal;
said risk diagnosing server performing overall diagnosis of said client terminal by computing risk level information, of every piece of software, included in the result of diagnosis of said client terminal;
said risk diagnosing server generating, by using a markup language, contents including the software specifying information, the risk level information, the storage location information and the result of overall diagnosis; and
said risk diagnosing server sending the contents to said client terminal, thereby presenting risk information to a user of said client terminal to induce the user to download software.

10. The method according to claim 1, wherein the software specifying information includes at least type-number information and edition-number information.

11. A computer program product for use with a computer composing a client terminal in a system including at least said client terminal, a risk information database for storing risk information with which risk level information, obtained by quantifying risk estimated from verified problems, is associated for every item of software specifying information that specifies software, and a risk diagnosing server for diagnosing risk of said client terminal, said computer program product comprising codes for causing said client terminal computer to execute the steps of:
receiving, from said risk diagnosing server, risk information with which risk level information obtained by quantifying risk estimated from verified problems, is associated for every item of software specifying information that specifies software;
acquiring software specifying information of software used on the side of said client terminal;
extracting data conforming to the software specifying information used on the side of said client terminal, from the risk information; and
sending result of the self-diagnosis to said risk diagnosing server.

12. The computer program product according to claim 11, further comprising codes for causing said client terminal computer to execute the steps of:
storing the result of self-diagnosis of the local side in storage means; and
outputting the stored result of self-diagnosis and to supply the stored result to the user.

13. The computer program product according to claim 11, wherein the software specifying information includes at least type-number information and edition-number information.

14. A computer program product for use with a computer composing a risk diagnosing server in a system including at least one client terminal, a risk information database for storing risk information with which risk level information, which is obtained by quantifying risk estimated from verified problems, is associated for every item of software specifying information that specifies software, and the risk diagnosing server for diagnosing risk of the client terminal, said computer program product comprising codes for causing said risk diagnosing server computer to execute the steps of:
extracting the risk information from the risk information database,
sending the risk information to said client terminal to cause said client terminal to perform self-diagnosis upon extracting data conforming to the software specifying information used on the side of said client terminal, from the risk information; and
outputting result of the display screen if the result of self-diagnosis has been sent from said client terminal.

15. The computer program product according to claim 14, further comprising codes for causing said risk diagnosing server computer to execute the steps of:
executing overall diagnosis of said client terminal by computing risk level information, of every piece of software, that is included in the result of self-diagnosis sent from said client terminal; and
outputting result of the overall diagnosis.

16. The computer program product according to claim 14, further comprising codes for causing said risk diagnosing server computer to execute the steps of:
extracting software specifying information and risk level information of software updateable on the side of said client terminal from said risk information database based upon software specifying information included in the result of self-diagnosis sent from said client terminal;
executing overall diagnosis on the side of said client terminal by computing risk level information, of every piece of software, included in the result of self-diagnosis sent from said client terminal; and
outputting the software specifying information and the risk level information together with the result of overall diagnosis.

17. A computer program product for use with a computer composing a risk diagnosing server in a system including at least one client terminal, a risk information database for storing, in associated form as risk information for every item of software specifying information that specifies software, risk level information obtained by quantifying risk estimated from verified problems, and storage location information of said software, and the risk diagnosing server for diagnosing risk of the client terminal, said computer program product comprising codes for causing said risk diagnosing server computer to execute the steps of:
extracting the risk information from the risk information database,
sending the risk information to said client terminal to cause said client terminal to perform self-diagnosis upon extracting data, conforming to the software specifying information used on the side of said client terminal, from the risk information;
on receipt of result of the self-diagnosis sent from said client terminal, extracting software specifying information, risk level information and storage location information of software updateable on the side of said client terminal from said risk information database based upon software specifying information included in the result of diagnosis of said client terminal;
executing overall diagnosis of said client terminal by computing risk level information, of every piece of software, included in the result of diagnosis of said client terminal;
creating, by using a markup language, contents including the software specifying information, the risk level information, the storage location information and the result of the overall diagnosis; and
sending the contents to said client terminal, thereby presenting risk information to a user of said client terminal to induce the user to download software.

18. The computer program product according to claim 14, wherein the software specifying information includes at least type-number information and edition-number information.

19. A computer program product for use with a computer composing a risk diagnosing server in a system including at least one client terminal, a risk information database for storing risk information with which risk level information, which is obtained by quantifying risk estimated from verified problems, is associated for every item of software specifying information that specifies software, and the risk diagnosing server for diagnosing risk of the client terminal, said computer program product comprising codes for causing said risk diagnosing server computer to execute the steps of:
accessing said client terminal to obtain software specifying information of software installed on the side of said client terminal;
extracting data conforming to the software specifying information of software installed on the side of said client terminal, from said risk information database to perform diagnosis of said client terminal; and
outputting result of diagnosis of said client terminal.

20. The computer program product according to claim 19, further comprising codes for causing said risk diagnosing server computer to execute the steps of:
executing overall diagnosis of said client terminal by computing risk level information, of every piece of software, included in the result of diagnosis of said client terminal; and
outputting result of the overall diagnosis.

21. The computer program product according to claim 19, further comprising codes for causing said risk diagnosing server computer to execute the steps of:
extracting software specifying information and risk level information of software updateable on the side of said client terminal from said risk information database, based upon software specifying information included in the result of diagnosis of said client terminal;
executing overall diagnosis of said client terminal by computing risk level information, of every piece of software, included in the result of diagnosis of said client terminal; and
outputting the software specifying information and the risk level information together with the result of overall diagnosis.

22. A computer program product for use with a computer composing a risk diagnosing server in a system including at least one client terminal, a risk information database for storing, in associated form as risk information for every item of software specifying information that specifies software, risk level information, obtained by quantifying risk estimated from verified problems, and storage location information of said software, and the risk diagnosing server for diagnosing risk of said client terminal, said program comprising codes for causing said risk diagnosing server computer to execute the steps of:
accessing said client terminal to obtain software specifying information of software installed on the side of said client terminal;
performing diagnosis of said client terminal upon extracting data, conforming to the software specifying information of software installed on the side of said client terminal, from said risk information database;
extracting software specifying information, risk level information and storage location information of software updateable on the side of said client terminal from said risk information database, based upon software specifying information included in the result of diagnosis of said client terminal;
executing overall diagnosis of said client terminal by computing risk level information, of every piece of software, included in the result of diagnosis of said client terminal;
creating, by using a markup language, contents including the software specifying information, the risk level information, the storage location information and result of overall diagnosis; and
sending the contents to said client terminal, thereby presenting risk information to a user of said client terminal to induce the user to download software.

23. The computer program product according to claim 19, wherein the software specifying information includes at least type-number information and edition-number information.

24. A client terminal comprising:
means for storing executably the computer program set forth in claim 11; and
means for causing a risk diagnosing server for diagnosing risk of a client terminal, to diagnose risk of said client terminal.

25. A risk diagnosing server apparatus having an interface for communication over a computer network, said server apparatus comprising:
means for storing executably the computer program set forth in claim 14; and
means for diagnosing risk of a client terminal connected to.

26. A risk diagnosing server apparatus having an interface for communication over a computer network with at least one client terminal for diagnosing risk of said client terminal, said risk diagnosing server apparatus accessible with a risk information database for storing risk information with which risk level information, obtained by quantifying risk estimated from verified problems, is associated for every item of software specifying information that specifies software, said risk diagnosing server apparatus comprising:
means for extracting the risk information from said risk information database to send the risk information to said client terminal;
means for receiving, from said client terminal, result of self-diagnosis of said client terminal obtained as a result of extraction of data, conforming to the software specifying information used on the side of said client terminal, from the risk information; and
means for outputting the result of self-diagnosis of said client terminal.

27. The risk diagnosing server apparatus according to claim 26, further comprising:
means for executing overall diagnosis of said client terminal by computing risk level information, of every piece of software, included in the result of self-diagnosis sent from said client terminal; and
means for outputting result of the overall diagnosis.

28. The risk diagnosing server apparatus according to claim 26, further comprising:
means for extracting software specifying information and risk level information of software that can be updated by said client terminal from said risk information database, based upon software specifying information included in the result of self-diagnosis sent from said client terminal;
means for executing overall diagnosis of said client terminal by computing risk level information, of every piece of software, included in the result of self-diagnosis sent from said client terminal; and
means for outputting the software specifying information and the risk level information together with the result of overall diagnosis.

29. A risk diagnosing server apparatus having an interface for communication over a computer network with at least one client terminal for diagnosing risk of said client terminal, said risk diagnosing server apparatus accessible with a risk information database for storing, in associated form as risk information for every item of software specifying information that specifies software, risk level information, obtained by quantifying risk estimated from verified problems, and storage location information of said software, said risk diagnosing server apparatus comprising:
means for extracting the risk information from said risk information database to send the risk information to said client terminal;
means for receiving, from said client terminal, result of self-diagnosis of said client terminal obtained as a result of extraction of data, conforming to the software specifying information used on the side of said client terminal, from the risk information; and
means for extracting software specifying information, risk level information and storage location information of software that can be updated by said client terminal from said risk information database, based upon software specifying information included in the result of self-diagnosis sent from said client terminal;
means for executing overall diagnosis of said client terminal by computing risk level information, of every piece of software, included in the result of self-diagnosis sent from said client terminal;
means for creating, by using a markup language, contents including the software specifying information, the risk level information, the storage location information and result of overall diagnosis; and
means for sending the contents to said client terminal, thereby presenting risk information to the user to induce the user to download software.

30. A risk diagnosing server apparatus having an interface for communication over a computer network with at least one client terminal for diagnosing risk of said client terminal, said risk diagnosing server apparatus accessible with a risk information database for storing risk information with which risk level information, obtained by quantifying risk estimated from verified problems, is associated for every item of software specifying information that specifies software, said risk diagnosing server apparatus comprising:
means for accessing said client terminal and acquiring software specifying information of software installed on the side of said client terminal;
means for performing diagnosis of said client terminal upon extracting data, conforming to the software specifying information installed in said client terminal, from said risk information database; and
means for outputting result of the diagnosis of said client terminal.

31. The risk diagnosing server apparatus according to claim 30, further comprising:
means for executing overall diagnosis of said client terminal by computing risk level information, of every piece of software, included in the result of diagnosis of said client terminal; and
means for outputting result of the overall diagnosis.

32. The risk diagnosing server apparatus according to claim 30, further comprising:
means for extracting software specifying information and risk level information of software updateable on the side of said client terminal from said risk information database, based upon the software specifying information included in the result of diagnosis of said client terminal;
means for executing overall diagnosis of said client terminal by computing risk level information, of every piece of software, included in the result of diagnosis of said client terminal; and
means for outputting the software specifying information and the risk level information together with the result of overall diagnosis.

33. A risk diagnosing server apparatus having an interface for communication over a computer network with at least one client terminal for diagnosing risk of said client terminal, said risk diagnosing server apparatus accessible with a risk information database for storing, in associated form as risk information for every item of software specifying information that specifies software, risk level information, obtained by quantifying risk estimated from verified problems, and storage location information of said software, said risk diagnosing server apparatus comprising:
means for accessing said client terminal to obtain software specifying information of software installed on the side of said client terminal;
means for extracting data, conforming to the software specifying information installed in said client terminal, from said risk information database to perform diagnosis of said client terminal;
means for extracting software specifying information, risk level information and storage location information of software updateable on the side of said client terminal from said risk information database, based upon software specifying information included in the result of diagnosis of said client terminal;
means for executing overall diagnosis of said client terminal by computing risk level information, of every piece of software, included in the result of diagnosis of said client terminal;
means for creating, by using a markup language, contents including the software specifying information, the risk level information, the storage location information and result of overall diagnosis; and
means for sending the contents to said client terminal, thereby presenting risk information to the user to induce the user to download software.

34. The risk diagnosing server apparatus according to claim 26, wherein the software specifying information includes at least type-number information and edition-number information.

35. The method according to claim 2, further comprising the steps of:
said client terminal storing the result of the self-diagnosis on the side of the said client terminal in storage means; and
said client terminal outputting the stored result of the self-diagnosis and supplying the stored result of self-diagnosis to a user of said client terminal.

36. The method according to claim 3, further comprising the steps of:
said client terminal storing the result of the self-diagnosis on the side of the said client terminal in storage means; and
said client terminal outputting the stored result of the self-diagnosis and supplying the stored result of self-diagnosis to a user of said client terminal.

37. The method according to claim 4, further comprising the steps of:
said client terminal storing the result of the self-diagnosis on the side of the said client terminal in storage means; and
said client terminal outputting the stored result of the self-diagnosis and supplying the stored result of self-diagnosis to a user of said client terminal.

38. The method according to claim 6, wherein the software specifying information includes at least type-number information and edition-number information.

39. The method according to claim 9, wherein the software specifying information includes at least type-number information and edition-number information.

40. The risk diagnosing server apparatus according to claim 29, wherein the software specifying information includes at least type-number information and edition-number information.

41. The risk diagnosing server apparatus according to claim 30, wherein the software specifying information includes at least type-number information and edition-number information.

42. The risk diagnosing server apparatus according to claim 31, wherein the software specifying information includes at least type-number information and edition-number information.

43. The risk diagnosing server apparatus according to claim 33, wherein the software specifying information includes at least type-number information and edition-number information.
